(19) United States
(12) Patent Application Publication
(10) Pub. No.: US 2013/0041727 A1
(43) Pub. Date: Feb. 14, 2013

(54) Method and system for aggregating merchant rewards

(71) Applicant: Joseph M. Baker, Lakeville, MN (US)

(72) Inventor: Joseph M. Baker, Lakeville, MN (US)

(21) Appl. No.: 13/572,307

(22) Filed: Aug. 10, 2012

Related U.S. Application Data
(60) Provisional application No. 61/523,127, filed on Aug. 12, 2011.

(51) Int. Cl. G06Q 30/02

(52) U.S. Cl. 705/14.3

(57) ABSTRACT

A loyalty rewards provider hosts a website providing registered users access to a loyalty rewards account for use at multiple merchants and retailers. This loyalty rewards provider has an established network of participating merchants allowing a user to accumulate and redeem loyalty rewards at multiple merchants. According to this system, a user is only required to have one loyalty rewards account that is used to accumulate all of their customer loyalty rewards which may be redeemed for cash and rewards at participating merchants free of charge. These rewards can be accessed online through a website or through a rewards card carried by the user.

### CROSS REFERENCE TO RELATED APPLICATIONS

This application claims the benefit of provisional patent application Ser. No. 61/523,127 filed 2011 Aug. 12 by the present inventor.

### FEDERALLY SPONSORED RESEARCH

Not Applicable

### SEQUENCE LISTING OR PROGRAM

Not Applicable

### FIELD OF THE INVENTION

The present invention relates to a computerized system and method for aggregating rewards, loyalty points, and rewarding cash back to purchasers across multiple merchants, traditional retailers, online retailers, and service providers.

### BACKGROUND OF THE INVENTION

Retailers, merchants, and service providers are constantly looking for ways to create repeat customers and repeat business. One way of generating this repeat business is through a rewards or loyalty program. In a standard program of this type, a user is presented with a rewards account. This account then generates points or credits based upon a number of factors including the user's frequency of purchases, amount of spending, number of visits, actions, events, or other measureable customer interactions. Often a user is presented a rewards card containing a unique identifier tied to the user to be used with this account. This card is presented to the provider at the time of a transaction where it is entered into a rewards system via scanning, swiping, or manual entry. Rewards are then accumulated with the user being offered discounts or cash back when a certain target or level of points is reached.

Most often a user is required to have multiple cards or accounts for multiple providers and the rewards can only be used with one specific retailer, merchant, or provider. Therefore a rewards system is needed to aggregate and collect customer loyalty rewards points or cash from multiple retailers to be used at multiple retailers. In addition, it is desired that a user can use one rewards card at all merchants throughout a network to aide in the accumulation of rewards. It is also desired that these rewards points or cash be redeemed at multiple merchants for discounts or cash back off of purchases.

### SUMMARY OF THE INVENTION

A loyalty rewards network (“Loyalty Provider”), is hosted in a datacenter accessible via the World Wide Web with a business or consumer accessing a webpage to create a loyalty rewards account or shop online. This loyalty rewards account will allow the business to reward their customers for their loyalty to the business and allow a consumer to be rewarded for their purchases made through the website or at a store. Consumers can also retrieve and view their specific account information with the Loyalty Provider by accessing their unique rewards account hosted in a datacenter and accessible via the World Wide Web, mobile application, or other internet enabled device.

A business or consumer will first visit the Loyalty Provider through a website hosted on the World Wide Web by accessing the website via a computer with web access. Preferably, the Loyalty Provider website will be easily accessible and located within the .com, .net, .biz, .org, or similar domain name registry. A user may also access the loyalty rewards network through a mobile device, smart phone, tablet, or other similar device with access to the internet. In addition, a user may access the loyalty rewards network using a dedicated application running on a smart phone, mobile device, tablet, personal computer, or other similar device.

The Loyalty Provider website will have four major functions: Consumer: online shopping, Consumer: loyalty registration, Business: loyalty program setup, and Advertiser: advertisement and promotion hosting.

A consumer will access the Loyalty Provider website to shop for items online. All of the items listed will provide the consumer with a cash back reward or loyalty point reward for a completed purchase. After entering the website, a consumer will have the ability to shop for goods online. A consumer may go directly to shopping for goods listed on the website or a user may register for an account with the Loyalty Provider to track and aggregate the consumers accumulated rewards.

To shop for goods, a consumer may either browse displayed links for a product or store or search for a specific product or store. A search will result in the display of active web links related to the search terms input by the consumer. To access a particular product or store a consumer will navigate to an active web link using a mouse, keyboard, or similar navigation device and click on the link using the corresponding device. Upon clicking on the active link, a consumer will be prompted, via a pop-up window or other similar mechanism, to enter their electronic mail (e-mail) address, if the consumer has not previously logged-in. If a consumer enters a valid e-mail address, they will be relocated to an affiliate website to begin shopping. If a consumer does not enter a valid e-mail address, they will be redirected back to the Loyalty Provider homepage and be unable to make a purchase.

Upon the consumer entering a valid e-mail address at the prompt or being previously registered, the Loyalty Provider will begin a background process of creating a unique identifier to be associated with the consumer's e-mail address. At this step, the Loyalty Provider sends a unique consumer identifier to the affiliate associated with the active link clicked on by consumer. This unique identifier (user ID) is then forwarded to the store visited to track any purchase(s) by the consumer associated with this newly created user ID.

Once at the affiliate website, the consumer will shop for an item. Eventually, the consumer will make a purchase decision, by either navigating away from the website where the transaction will end or following through on the purchase of the item. The item purchased will then be shipped to the consumer in the normal course of business of the affiliate website. After making a purchase, the consumer will receive an e-mail from the Loyalty Provider prompting the consumer to complete registration, if the consumer has not previously registered, and notifying the consumer of their rewards and/or cash balance.

The purchase will initiate a series of background processes beginning with the online store where the purchase was made informing the affiliate network from the Loyalty Provider which user ID made the purchase, what was purchased, how much was spent, and what was the commission on the sale. The affiliate network provides the identical information to the Loyalty Provider and provides the Loyalty Provider payment of the appropriate commission.

The Loyalty Provider will then use the information provided to reward the consumer corresponding to the user ID for their purchase. In the preferred embodiment, this reward is a dollar amount, although other rewards such as a discount, a point, or any combination of these may be used. This reward can be given to the user, a user directed charity, non-profit, or other loyalty network provided eligible organization, a broker, or a master broker. This reward will be awarded according to an established commission schedule that the loyalty provider has established and notified the user of This reward amount will then be credited to the consumer's account, wherein after making a qualified purchase the user will see in an increase in dollars in their rewards account.

Upon entering the Loyalty Provider website, a consumer intending to shop online may go directly to registration and create a rewards account or log-in to an existing account. Registration will allow the consumer to enter their personal information optionally including, but limited to, their name, street address, state, zip code, phone number, e-mail address, gender, date of birth, household income, education level, income level, relationship status, number of children, other indentifying characteristics, and create a password to be associated with their e-mail address. This information will then be stored on a server within the datacenter and maintained in a database for future access.

Additionally, the Loyalty Provider website will allow traditional retail consumers the ability to register for loyalty rewards. This will encourage repeat business at traditional brick and mortar merchants and provide consumers a cash back benefit for shopping. The Loyalty Provider provides consumers access to a vast loyalty network where aggregated and accumulated rewards may be used. A consumer making a purchase at a traditional brick and mortar merchant will be able to use cash back or rewards accumulated through purchases made online as a discount on any purchases made at the traditional brick and mortar merchant.

To facilitate the above stated process, the Loyalty Provider will provide a loyalty card or unique identifier to brick and mortar merchants to be distributed to their customers. Each loyalty card provided to a consumer will have a unique identifier tied to the consumer, whereby a consumer can register, accumulate rewards, and use this card across the entire rewards network established by the Loyalty Provider. This card can be customized to an individual retailer and will contain a bar code or magnetic strip allowing a merchant to quickly and efficiently retrieve a consumer's reward information.

According to this process, the Loyalty Provider has established a network of participating merchant's where any accumulated loyalty rewards can be used. These merchants may be larger big box retailers or brick and mortar stores with both a local and national retail presence. Under this type of loyalty reward, a consumer will make a purchase at the physical location of the participating merchant's store. If a consumer already has a loyalty card, they will proceed with presenting the loyalty card to cashier at the time of purchase.

If the consumer does not already have a loyalty card, the merchant may inquire if the consumer would like to establish loyalty rewards account. If the consumer would like to establish an account, the merchant will open a new loyalty account on behalf of the consumer. To open this account, the merchant will use a previously provided and unassigned loyalty card, login to the Loyalty Provider network, and create a new user account with the consumer information linked to the previously unassigned loyalty card. At this registration step, the merchant is required to collect the consumer's name and e-mail address to be associated with the loyalty card. If the consumer at the merchant location provides an email address of an existing account holder, the Loyalty Provider will prompt the merchant that this customer already has an account and will be directed to the consumers previously created account. A consumer can then, at their leisure, visit the Loyalty Provider website and complete the registration process.

After a consumer has presented a loyalty card to the merchant, the merchant cashier will scan, swipe, key, or otherwise enter the loyalty card into the Loyalty Provider system. A background process will occur within the Loyalty Provider database where the consumer's loyalty account will be located. The merchant will then see the consumer's loyalty rewards balance. If the consumer's loyalty card has a positive cash balance, the user may redeem a portion or the full amount of this cash back reward towards the consumer's purchase. If the consumer does not have a positive rewards balance or chooses not to redeem their cash back loyalty reward, the transaction will continue with the consumer paying the full amount due and owing.

When a consumer decides to use their accumulated loyalty rewards or a portion of these rewards for a given transaction, the merchant transaction is processed similar to redeeming a gift card or pre paid debt card with the exception that the merchant is not charged an interchange fee as with a traditional credit or debit transfer. Concurrently, the Loyalty Provider conducts a series of background processes to handle the redemption of a consumer reward.

After the merchant redeems the balance, the transaction amount is transferred to a database hosted by the Loyalty Provider and marketed for transfer. Once daily, the Loyalty Provider processes these transactions marked for transfer and initiates an Automated Clearing House (ACH) transaction to the business checking account. This transaction is monitored by the Loyalty Provider to ensure it is processed. If the transaction is processed, it will repeat again the following day. If the transaction is not processed, it will be processed again. After the transaction occurs, the Loyalty Provider will deduct the available cash balance from the consumer's loyalty rewards account. The consumer account will remain depleted until an additional accumulating transaction is made with the Loyalty Provider through a purchase using the consumer's rewards account, this process will repeat as the account is used to collect and redeem rewards.

In addition to a purchase at a brick and mortar store, a consumer may purchase a voucher for a given local or national retailer on the Loyalty Provider website. The consumer may purchase this voucher using accumulated loyalty rewards or by using a credit or debit card. If the consumer makes the voucher purchase using their existing rewards, the transaction will move to the database marked for transfer. The voucher will then be credited to the consumer's loyalty account. If the user uses a credit or debit card to purchase the voucher, the card is processed and the voucher is credited to the consumer's loyalty account. The voucher will be available for the consumer to use when making purchases.

Further, the Loyalty Provider website will allow for the set-up of a business loyalty rewards program and be used to advertise and promote businesses and products. A new business wanting a loyalty rewards program will have the ability to work with the Loyalty Provider and its network to offer customers a unique loyalty rewards experience. A business wanting a loyalty rewards program will be required to establish an account prior to the accepting or granting of rewards. The Loyalty Provider will host the rewards program using its existing database, software, and networks. The Loyalty Provider will register the business and collect pertinent information related to the business optionally including, but not limited, to the name, street address, state, zip code, e-mail address, contact person, and phone number. This business information will be stored in a Loyalty Provider database for later retrieval. The business will then be granted a unique user name and password to manage their communications and transactions with Loyalty Provider and be given loyalty reward cards to present to customers looking to be rewarded for purchases made at the business. The business will then be able to access account information and sign up new customers to the Loyalty Provider network through a web based portal hosted on the World Wide Web.

The Loyalty Provider website will also host advertisements and promotions by providing advertising space within the confines of website. The Loyalty Provider will load and store these advertisers and advertisements into a local database. The Loyalty Provider website will display the advertiser's information. The display of advertisements can be static or dynamic based upon an individual consumer's website interactions or past history on the website. All advertisements displayed will provide Universal Resource Locator (URL) links allowing a consumer to easily access, through the internet, an individual advertiser's website. These displayed links are unique to each registered user, so a user's purchases or visits can be tracked and accounted for.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1a is a flow diagram of the system and method, according to the present invention;

FIG. 1b is a continuation of the flow diagram of the system and method, according to the present invention;

FIG. 1c is a continuation of the flow diagram of the system and method, according to the present invention.

FIG. 1d is a continuation of the flow diagram of the system and method, according to the present invention.

### DETAILED DESCRIPTION OF THE INVENTION

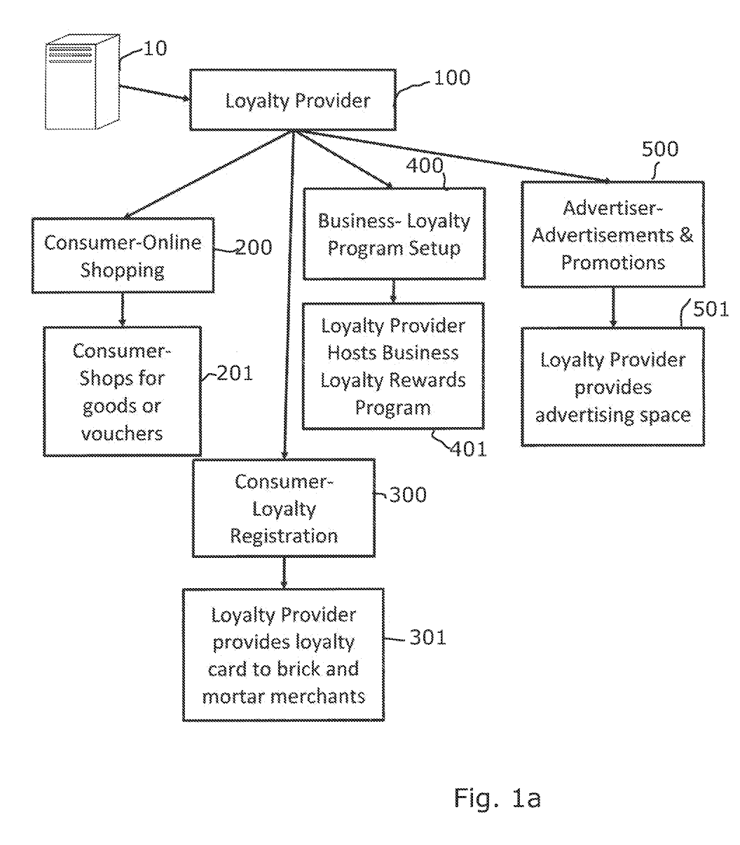

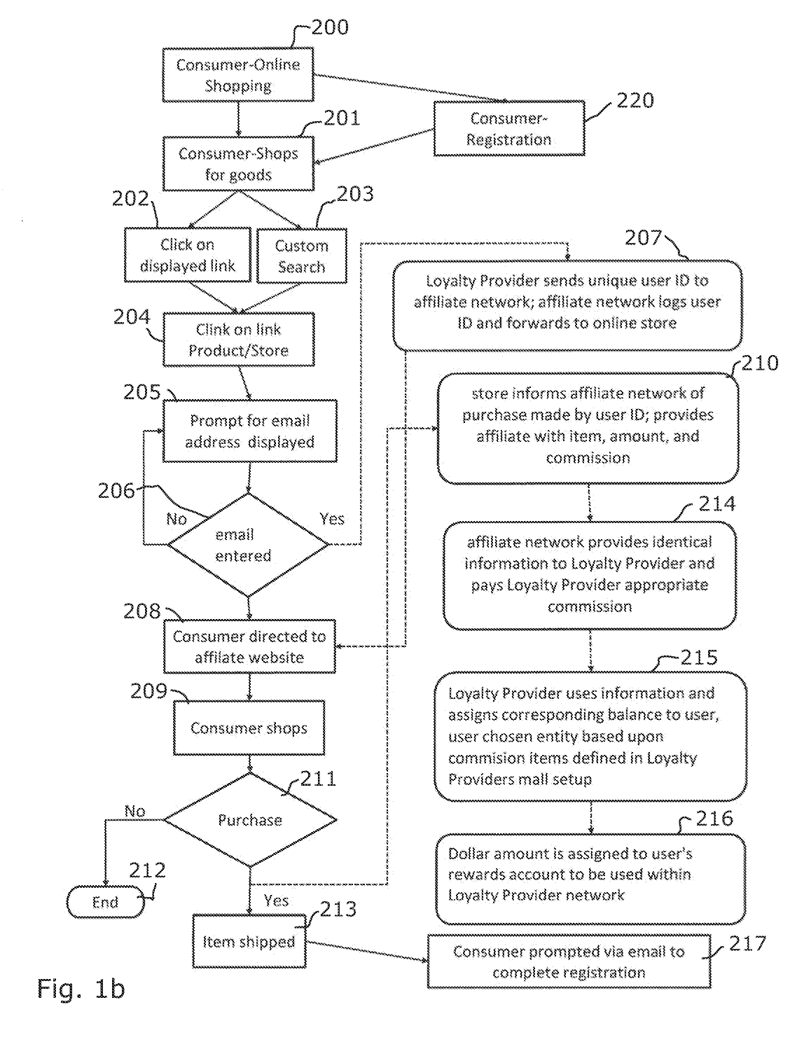

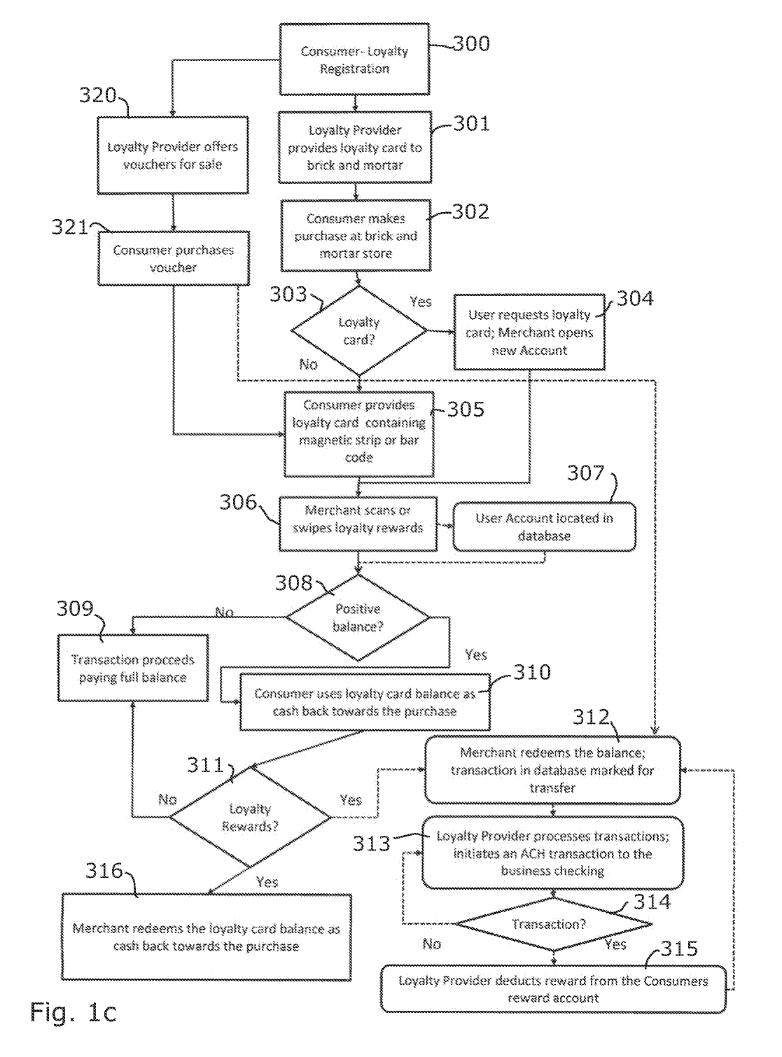

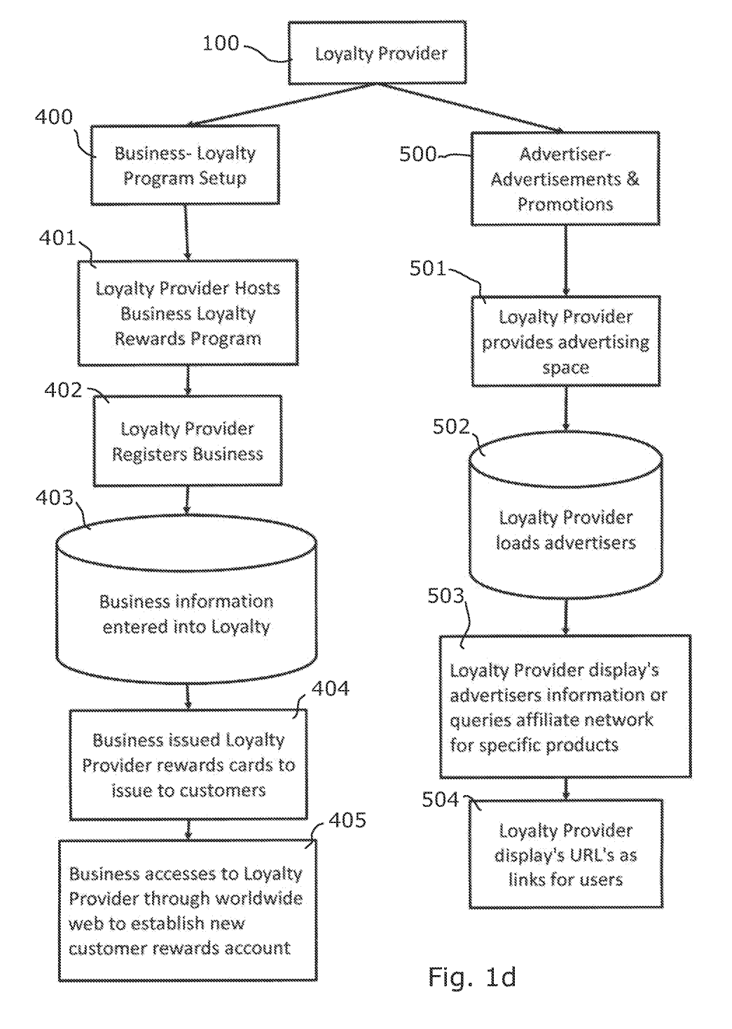

Referring now to FIGS. 1a-1d there is shown a flow diagram of the loyalty rewards system and method of the present invention. In the preferred embodiment of the present invention, the loyalty rewards network (“Loyalty Provider”) will be hosted in a datacenter accessible via the World Wide Web with a business or consumer accessing a webpage to create a loyalty rewards account or shop online. This account will allow the business to reward their customers for their loyalty to the business and allow a consumer to be rewarded for their purchases made through the website. Consumers can also retrieve and view their specific account information with the Loyalty Provider by accessing their unique rewards account hosted in a datacenter and accessible via the World Wide Web, mobile application, or other internet enabled device.

A business or consumer will first visit the Loyalty Provider website 100 by accessing the website via a computer 10 with web access. Preferably, Loyalty Provider website 100 will be easily accessible and located within the .com, .net, .biz, .org, or similar domain name registry. A user may also access the loyalty rewards network through a mobile device, smart phone, tablet, or other similar device with access to the internet. In addition, a user may access the loyalty rewards network using a dedicated application running on a smart phone, mobile device, tablet, personal computer, or other similar device.

The Loyalty Provider website 100 will have four major functions: Consumer: online shopping 200, Consumer: loyalty registration 300, Business: loyalty program setup 400, and Advertiser: advertisement and promotion hosting 500.

Referring now to FIG. 1b, a flow diagram of the Consumer online shopping portion 200 of Loyalty Provider website 100, a consumer will access the Loyalty Provider website 100 to shop for items online. All of the items listed will provide the consumer with a cash back reward or loyalty point reward for a completed purchase. After entering website 100, a consumer will have the ability to shop for goods online 201. A consumer may go directly to shopping for goods 201 listed on website 100 or a user may register 220 for an account with Loyalty Provider to track and aggregate the consumers accumulated rewards.

To shop for goods a consumer may either browse displayed links for a product or store 202 or search for a specific product or store 203. A search 203 will result in the display of active web links 204 related to the search terms input by the consumer. To access a particular product or store a consumer will navigate to an active web link using a mouse, keyboard, or similar navigation device and click on the link 204 using the corresponding device. Upon clicking on the active link 204, a consumer will be prompted, via a pop-up window or other similar mechanism, to enter their electronic mail (e-mail) address 205, if the consumer has not previously logged-in. If a consumer enters a valid e-mail address they will be relocated to an affiliate website to begin shopping 208. If a consumer does not enter a valid e-mail address, they will be redirected back to the Loyalty Provider homepage and be unable to make a purchase.

Upon the consumer entering a valid e-mail address at the prompt 206, or being previously registered, Loyalty Provider will begin a background process of creating a unique identifier to be associated with the consumer's e-mail address 207. At this step 207, Loyalty Provider sends a unique consumer identifier to the affiliate associated with the active link clicked on by consumer. This unique identifier (user ID) is then forwarded to the store visited 207 to track any purchase(s) by the consumer associated with this newly created user ID.

Once at the affiliate website 208, the consumer will shop for items 209. Eventually, the consumer will make a purchase decision, by either navigating away from the website where the transaction will end 212 or following through on the purchase of an item 211. The item purchased at 211 will then be shipped to the consumer in the normal course of business of the affiliate website 213. After making a purchase, the consumer will receive an e-mail from Loyalty Provider prompting the consumer to complete registration 220, if the consumer has not previously registered, and notifying the consumer of their rewards and/or cash balance 217.

A purchase at step 211 will initiate a series of background processes beginning with the online store where the purchase was made informing the affiliate network from the Loyalty Provider which user ID made the purchase, what was purchased, how much was spent, and what was the commission on the sale 210. The affiliate network provides the identical information to the Loyalty Provider and provides the Loyalty Provider payment of the appropriate commission 214.

The Loyalty Provider will then use the information provided in step 214 to reward the consumer corresponding to the user ID for their purchase 211. In the preferred embodiment, this reward is a dollar amount, although other rewards such as a discount, a point, or any combination of these may be used. At step 215 this reward can be given to the user, a user directed charity, non-profit, or other loyalty network provided eligible organization, a broker, or a master broker. This reward 215 will be awarded according to an established commission schedule that the loyalty provider has established and notified the user of This reward amount will then be credited to the consumer's account 216 wherein after making a qualified purchase the user will see in an increase in dollars in their rewards account.

Upon entering Loyalty Provider website 100, a consumer intending to shop online may go directly to registration and create a rewards account 220 or log-in to an existing account. Registration 220 will allow the consumer to enter their personal information optionally including, but limited to, their name, street address, state, zip code, phone number, e-mail address, gender, date of birth, household income, education level, income level, relationship status, number of children, other indentifying characteristics, and create a password to be associated with their e-mail address. This information will then be stored on a server within the datacenter and maintained in a database (not pictured) for future access.

Referring now to FIG. 1c, Loyalty Provider website 100 will allow traditional retail consumers the ability to register for loyalty rewards 300. To encourage repeat business at traditional brick and mortar merchants and to provide consumers a cash back benefit for shopping 200, Loyalty Provider provides consumers access to a vast loyalty network where aggregated and accumulated rewards may be used. A consumer making a purchase at a traditional brick and mortar merchant will be able to use cash back or rewards accumulated through purchases made online as a discount on any purchases made at the traditional brick and mortar merchant.

To facilitate the above stated process, Loyalty Provider will provide a loyalty card or unique identifier to brick and mortar merchants to be distributed to their customers 301. Each loyalty card provided to a consumer will have a unique identifier tied to the consumer, whereby a consumer can register, accumulate rewards, and use this card across the entire rewards network established by Loyalty Provider. This card can be customized to an individual retailer and will contain a bar code or magnetic strip allowing a merchant to quickly and efficiently retrieve a consumer's reward information.

According to this process at step 301, Loyalty Provider has established a network of participating merchant's where any accumulated loyalty rewards can be used. These merchants may be larger big box retailers or brick and mortar stores with both a local and national retail presence. Under this type of loyalty reward, a consumer will make a purchase at the physical location of the participating merchant's store 302. If a consumer already has a loyalty card 303, they will proceed with presenting the loyalty card to cashier at the time of purchase 305.

If the consumer does not already have a loyalty card 303, the merchant may inquire if the consumer would like to establish loyalty rewards account. If the consumer would like to establish an account, the merchant will open a new loyalty account on behalf of the consumer 304. To open this account, the merchant will use a previously provided and unassigned loyalty card 301, login to the Loyalty Provider network, and create a new user account with the consumer information linked to the previously unassigned loyalty card. At this registration step 304 the merchant is required to collect the consumer's name and e-mail address to be associated with the loyalty card. A consumer can then, at their leisure, visit Loyalty Provider website 100 and complete the registration process at step 220.

After a consumer has presented a loyalty card to the merchant at step 305, the merchant cashier will scan, swipe, key, or otherwise enter the loyalty card into the Loyalty Provider system 306. A background process will occur within Loyalty Provider database where the consumer's loyalty account will be located 307. The merchant will then see the consumer's loyalty rewards balance 308. If the consumer's loyalty card has a positive cash balance 308, the user may redeem a portion or the full amount of this cash back reward towards the consumer's purchase 310. If the consumer does not have a positive rewards balance at step 308 or chooses not to redeem their cash back loyalty reward 311, the transaction will continue with the consumer paying the full amount due and owing 309.

When a consumer decides to use their accumulated loyalty rewards or a portion of these rewards for a given transaction 311, the merchant transaction is processed similar to redeeming a gift card or pre paid debt card with the exception that the merchant is not charged an interchange fee as with a traditional credit or debit transfer. Concurrently, Loyalty Provider conducts a series of background processes to handle the redemption of a consumer reward outlined in 312 through 315.

In step 312, after the merchant redeems the balance in 311, the transaction amount is transferred to a database hosted by Loyalty Provider and marketed for transfer. Once daily, the Loyalty Provider processes these transactions marked for transfer and initiates an Automated Clearing House (ACH) transaction to the business checking account as highlighted in step 313. This transaction is monitored by Loyalty Provider to ensure it is processed 314. If the transaction is processed, it will repeat again the following day at 312. If the transaction is not processed, it will be processed again 313. After the transaction occurs, Loyalty Provider will deduct the available cash balance from the consumer's loyalty rewards account 315. The consumer account will remain depleted until an additional accumulating transaction is made with the Loyalty Provider at 100, this process will repeat as the account is used to collect and redeem rewards.

In addition to a purchase at a brick and mortar store, a consumer may purchase a voucher for a given local or national retailer on the Loyalty Provider website 320. The consumer may purchase this voucher using accumulated loyalty rewards or by using a credit or debit card 321. If the consumer makes the voucher purchase using their existing rewards 321, the transaction will move to the database marked for transfer at step 312. The voucher will then be credited to the consumer's loyalty account. If the user uses a credit or debit card to purchase the voucher, the card is processed and the voucher is credited to the consumer's loyalty account. The voucher will be available for the consumer to use when making purchases 305.

Referring now to FIG. 1d, Loyalty Provider website 100 will allow for the set-up of a business loyalty rewards program 400 and be used to advertise and promote businesses and products 500. A new business wanting a loyalty rewards program will have the ability to work with Loyalty Provider and its network to offer customers a unique loyalty rewards experience 400. Loyalty Provider will host the rewards program using its existing database, software, and networks 401. Loyalty Provider will register the business 402 and collect pertinent information related to the business optionally including, but not limited, to the name, street address, state, zip code, e-mail address, contact person, and phone number. This business information will be stored in a Loyalty Provider database for later retrieval 403. The business will then be granted a unique user name and password to manage their communications and transactions with Loyalty Provider and be given loyalty reward cards to present to customers looking to be rewarded for purchases made at the business 404. Business will then be able to access account information and sign up new customers to Loyalty Provider network through a web based portal hosted on the World Wide Web 405.

Loyalty Provider website 100 will also host advertisements and promotions 500 by providing advertising space 501 within the confines of website 100. Loyalty Provider will load and store these advertisers and advertisements into a local database 502. The Loyalty Provider website 100 will display the advertiser's information 503. The display of advertisements can be static or dynamic based upon an individual consumer's website interactions or past history on the website 100. All advertisements displayed will provide Universal Resource Locator (URL) links 504 allowing a consumer to easily access, through the internet, an individual advertiser's website. These displayed links are unique to each registered user, so a user's purchases or visits can be tracked and accounted for.

What is claimed is:

1. A method for providing a loyalty rewards network of participating online and traditional merchants for rewarding a consumer for purchases made at both online and traditional merchants by the consumer, the method being computer-implemented and hosted on a loyalty provider website, the method comprising:
the consumer creating a user account online through the loyalty provider website or in person at a traditional brick and mortar merchant;
the consumer being assigned a unique identification to be associated with the account and used across the loyalty rewards network, the unique identification being affixed to an email address of the consumer, the email address used to track and aggregate purchases made through the loyalty rewards network;
providing the traditional brick and mortar merchant with the ability to create a loyalty rewards network account for consumers who are not yet participants in the loyalty rewards network for participation in the loyalty rewards network, the traditional brick and mortar retailers electronically connected to the loyalty provider through a network connection having access to the loyalty provider website, the creation of a new account requires the consumer to provide an email address to be associated with the newly created loyalty rewards network account;
the loyalty provider website linked to online merchants participating in the loyalty rewards network, the consumer providing their email address upon accessing the loyalty provider website to track to purchases made online and initiated through the loyalty provider website;
the loyalty rewards provider tracking all of the consumer purchases made throughout the loyalty rewards network and assigning rewards to these purchases to be associated with the consumers loyalty rewards network account; and
the consumer being able to redeem accumulated rewards at the time of purchase at either an online merchant or a traditional brick and mortar merchant.

2. The method of claim 1, wherein the reward is monetary in the form of a cash back on purchases made across the loyalty rewards network.

3. The method of claim 1, wherein the redemption of consumer rewards at a traditional brick and mortar merchant is completed without an interchange fee.

4. The method of claim 1, wherein the traditional brick and mortar merchant provides the consumer with a loyalty rewards card unique to each consumer and assigned to the consumers loyalty rewards account for tracking rewards earned across the loyalty rewards network.

5. The method of claim 4, wherein the loyalty rewards card includes a magnetic strip containing the consumers loyalty rewards account information.

6. The method of claim 4, wherein the loyalty rewards card includes a unique bar code containing the consumers loyalty rewards account information.
